(19) United States
(12) Patent Application Publication
(10) Pub. No.: US 2009/0031147 A1
(43) Pub. Date: Jan. 29, 2009

(54) APPARATUS FOR WAKING UP A DEVICE

(75) Inventor: Helmut Horvat, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/782,100

(22) Filed: Jul. 24, 2007

(51) Int. Cl. G06F 1/26

(52) U.S. Cl. 713/300

(57) ABSTRACT

Apparatus for waking up a device having a power supply. The apparatus includes a receiver configured to receive a receive signal and an extractor configured to extract power from the receive signal. The apparatus further includes a deriver configured to derive wake up information from the receive signal, which is powered by the extracted power. Furthermore, the apparatus includes an effecter configured to effect a connection of the device to the power supply if the deriver derives the wake up information.

### BACKGROUND OF THE INVENTION

The present invention relates to the field of standby power consumption, as it is carried out by various devices utilizing a standby mode.

Devices utilizing a standby mode, for example television sets, DVD players (DVD=Digital Versatile Disk), VCRs (VCR=Video Cassette Recorder) etc., are mostly connected to a power supply network and utilize only low power when being operated in standby mode. Taking the large number of devices worldwide into consideration which are operated in standby mode, in sum these devices waste an enormous amount of power resources. Other devices, which are not connected to a power supply network, utilize battery or accumulator power when being operated in standby mode. Especially for mobile devices, for example mobile phones, the power consumption in standby mode limits the standby times, i.e. the time which a mobile device can be operated on battery power and after which it needs to be connected to a charging device again in order to prevent service down times due to lack of power.

### SUMMARY OF THE INVENTION

According to an embodiment, the present invention comprises an apparatus for waking up a device having a power supply, comprising a receiver configured to receive signal and extractor configured to extract power from the receive signal. The apparatus further comprises a deriver configured to derive a wake up information from the receive signal, wherein the deriver is powered by the extracted power. The apparatus further comprises an effecter configured to effect a connection of the device to the power supply if the deriver derives the wake up information.

According to another embodiment, the present invention further comprises an apparatus for waking up a device having a power supply, wherein the apparatus comprises an antenna, which is adapted for receiving a receive signal. The apparatus further comprises a power extractor being coupled to the antenna and adapted for extracting power from the receive signal. The apparatus further comprising a demodulator powered by the power extracted from the received signal, which is adapted for deriving a wake up information and for outputting a trigger signal for connecting the device to the power supply.

According to another embodiment, the present invention comprises an apparatus for triggering a wake up of a device having a power supply. The apparatus comprises an antenna having a receive signal output and a power extractor having an input being coupled to the receive signal output and having a power signal output. The apparatus further comprises a demodulator having a first input being coupled to the receive signal output and having a second input being coupled to the power signal output, the demodulator further having an output for a trigger signal.

According to another embodiment the present invention comprises a system for waking up a device having a power supply, the system comprising a transmitter for transmitting a transmit wake up signal, the transmit wake up signal comprising a modulated carrier and a wake up information. The system further comprises a receiver, comprising one of the abovementioned embodiments.

According to another embodiment, the present invention further comprises a device comprising one of the abovementioned embodiments.

### BRIEF DESCRIPTION OF THE FIGURES

Embodiments of the present invention will be detailed using the accompanying figures, in which:

FIG. 1a shows an embodiment of an apparatus for waking up a device;

FIG. 1b shows another embodiment of an apparatus for waking up a device;

FIG. 2a shows yet another embodiment of an apparatus for waking up a device;

FIG. 2b shows yet another embodiment of an apparatus for waking up a device;

FIG. 2c shows yet another embodiment of an apparatus for waking up a device;

FIG. 3a shows an embodiment of a transmitter;

FIG. 3b shows another embodiment of a transmitter; and

FIG. 3c shows yet another embodiment of a transmitter.

### DETAILED DESCRIPTION OF THE EMBODIMENTS

Conventional systems for waking up devices, which are in a standby mode, may utilize circuits, comprising a receiver, a switch and a power supply. Conventional systems may therewith receive a wake up signal and switch the device back to a normal mode. As the wake up signal can occur anytime, the receiver is therefore always switched on, i.e. always consuming power. Many conventional systems use a remote control to provide a wake up signal to a receiver, wherein the wake up signal then triggers a switch, switching the device back to normal mode. The power supply can be connected to a power supply network, however, it can also be connected to a battery, an accumulator, or generally to any energy buffer. Consequently, conventional systems consume power all the time, regardless whether they are in standby mode or in normal mode.

Embodiments take advantage of the received power inherited in a receive signal. Energy comprised in the receive signal can be utilized to operate a receiver, which in turn triggers a wake up signal, or simply a switch, switching a device from standby mode to normal mode. By utilizing energy being supplied with the signal itself, rather than from a local power supply, embodiments can enable a standby mode for devices consuming almost zero power.

Embodiments thereby use power supply units, which extract the power from a receive signal, and are not connected to any power supply network or energy buffer. Energy can be supplied over the air interface, in a wireless manner and may be supplied by a remote control.

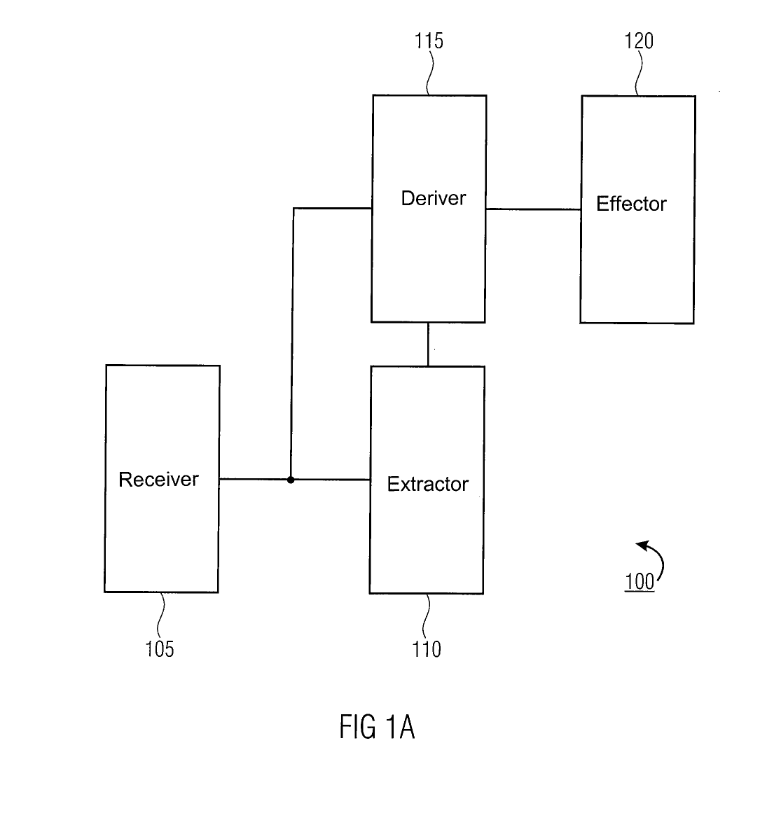

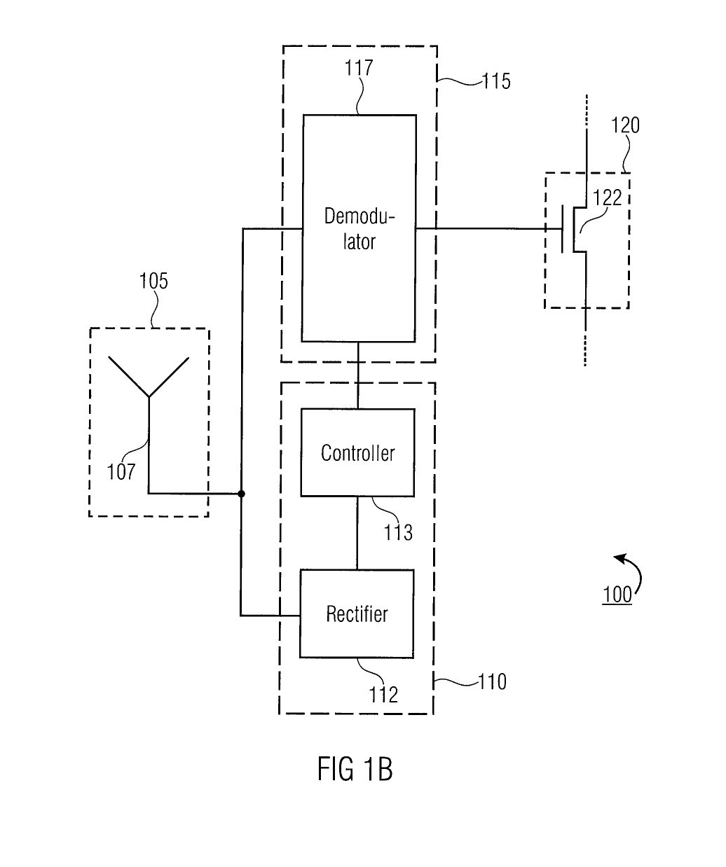

FIG. 1a shows an apparatus 100 for waking up a device having a power supply. The apparatus 100 comprises a receiver 105 configured to receive a receive signal. The apparatus 100 further comprises an extractor 110 configured to extract power from the receive signal and a deriver 115 configured to derive a wake up information from the receive signal, which is powered by the extracted power. The apparatus further comprises an effecter 120 configured to effect a connection of the device to the power supply if the deriver 115 derives the wake up information.

FIG. 1b shows another embodiment of an apparatus 100 for waking a device. The apparatus 100 shown in FIG. 1b comprises the receiver 105, the extractor 110, the deriver 115 and the effecter 120. According to FIG. 1a, the receiver 105 may be implemented as a receive antenna 107. The extractor 110 may comprise a rectifier 112. In embodiments, the extractor 110 may comprise an energy buffer, which may be implemented as a capacitive or inductive element. In embodiments, the extractor 110 can also comprise a controller 113 for controlling the provided power. The deriver 115 may comprise a demodulator 117. Moreover, the effecter 120 may be adapted for triggering an electrical or mechanical switch 122, which may connect a device to its power supply.

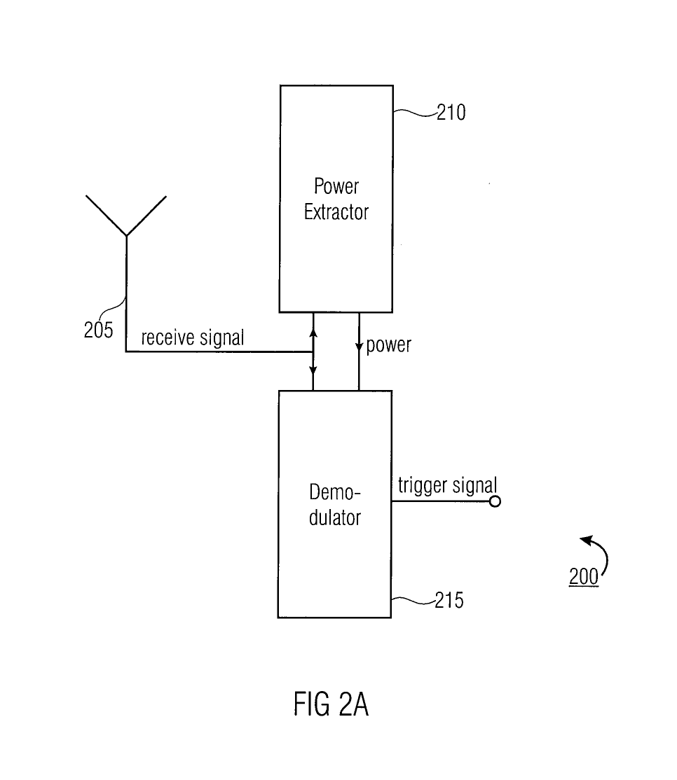

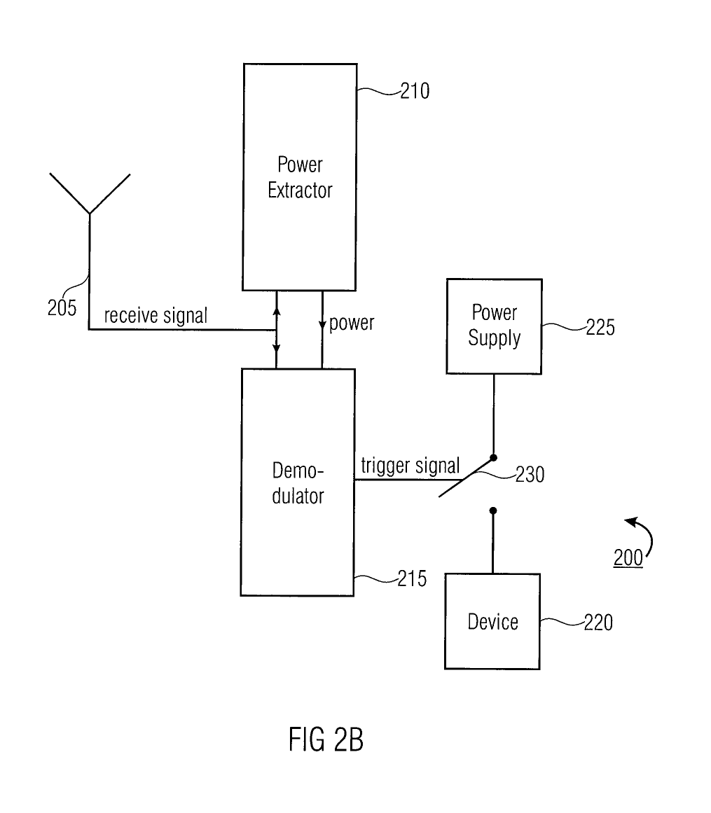

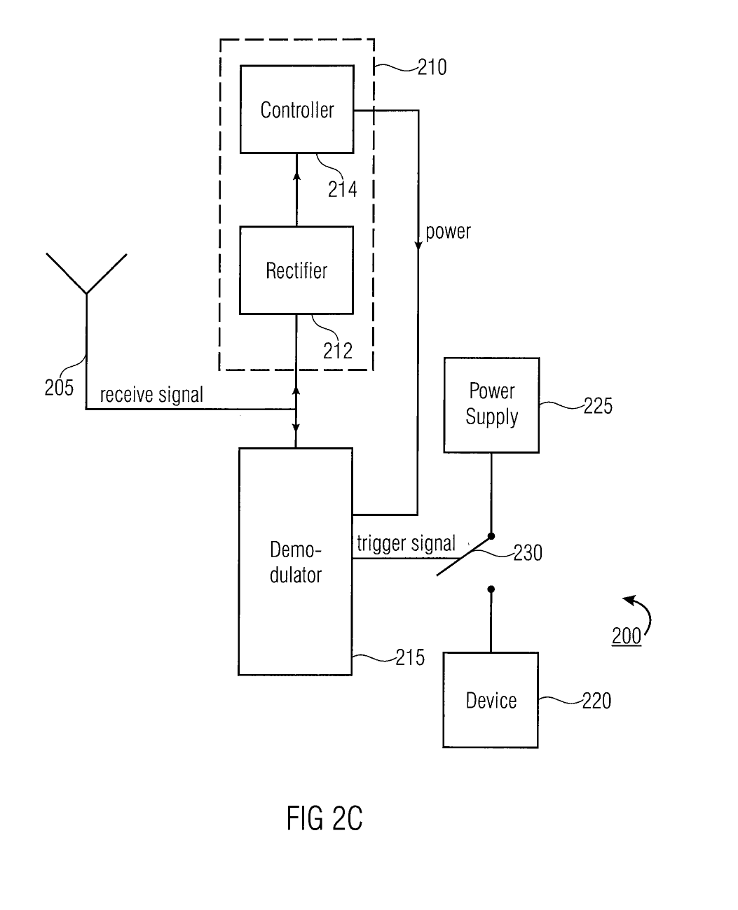

FIG. 2a shows another embodiment of an apparatus 200 for waking up a device having a power supply, in which the apparatus 200 comprises an antenna 205 adapted for receiving a receive signal. The apparatus 200 further comprises a power extractor 210 coupled to the antenna and adapted for extracting power from the receive signal. The apparatus 200 further comprises a demodulator 215 powered by the power extracted from the receive signal and adapted for deriving a wake up information and for outputting a trigger signal for connecting the device to the power supply.

FIG. 2b shows another embodiment of an apparatus 200 for waking up a device. FIG. 2b shows the same components as were discussed above with the aid of FIG. 2a. Additionally, FIG. 2b shows a device 220 and its power supply 225. FIG. 2b shows the demodulator 215 triggering a switch 230 with the trigger signal, and therewith effecting a connection between the power supply 225 and the device 220. As an example in FIG. 2b, the switch 230 can be implemented as a mechanical switch. In embodiments all kinds of switches are conceivable to be triggered with the trigger signal. For example transistors, as field effect transistors or bipolar transistors may be utilized to effect a connection between a device 220 and its power supply 225.

FIG. 2c shows another embodiment of an apparatus 200 having similar components as discussed above. In the embodiment shown in FIG. 2c the power extractor 210 is implemented utilizing a rectifier 212 and a controller 214. Again, the rectifier 212 may utilize diodes for rectifying the receive signal and energy buffers for buffering the energy. The controller 214 may use energy buffers or controller circuits in order to stabilize the power supplied for the demodulator 215 in order to provide the trigger signal as a wake up signal. Energy buffers can be implemented utilizing capacitive or inductive elements.

Embodiments can further provide apparatuses 200 for triggering a wake up of a device 220 having a power supply 225. The apparatus 200 comprises an antenna 205 having a receive signal output. Furthermore, the apparatus 200 comprises a power extractor 210 having an input being coupled to the receive signal output and having a power signal output. Moreover, the apparatus 200 comprises a demodulator 215 having a first input being coupled to the receive signal output and having a second input being coupled to the power signal output, the demodulator 215 further having an output for a trigger signal.

Embodiments may be implemented in standby-circuits comprising a receiver and a switch, wherein the receiver receives a transmit signal from, for example, a remote control, utilizing the power of the signal and additionally wake up information comprised in the signal. An according transmitter or remote control may transmit a radio signal upon activation of a switch or button, wherein wake up information or switch on information is modulated onto the radio signal.

According to the above-described embodiments, a receiver or an apparatus (100;150;200) may comprise an antenna (107;205), a demodulator (117;215), a rectifier (112;212) and a controller (113;214). The apparatus (100;150;200) provides a trigger signal, wherein the receive antenna (107;205) may convert electromagnetic waves or oscillations in voltage or current. The rectifier (112;212) may extract a DC voltage or current from the electromagnetic oscillation or wave, supplying sufficient power to operate the standby circuit or apparatus (100;150;200). The controller (113;214) may equalize fading of the received radio signal, for example utilizing energy buffers as capacitive or inductive elements. A wake up signal or switch on signal can be modulated to the electromagnetic oscillation or wave and can then be extracted from the demodulator (117;215) and be utilized to trigger a switch.

Moreover in embodiments apparatuses (100;150;200) may be further adapted for receiving a dedicated receive signal, i.e. for decoding a certain sequence within the receive or wakeup signal. In embodiments a wake up signal may comprise a certain identification of a apparatus (100;150;200), which may be configured to only provide a trigger signal for the power supply if the wake up signal comprises the identification or code. Moreover the identification or code may be encrypted and in embodiments the apparatus (100;150;200) may further comprise a decrypter or identifier configured to decrypt or identify the identification or code in the wake up signal. The decrypter or identifier may be comprised in the deriver 115 or the demodulator 215. Therewith integrity protection and security can be established for a wake up signal. In embodiments encryption may also serve for energy efficient coding, so to enable low energy transmissions of wake up signals. In other embodiments the apparatus (100;150;200) may be further adapted to detect, whether a collision of multiple wake up signals occurred, i.e. the apparatus may comprise an anticollision unit in other embodiments. If multiple wake up signals are received within a certain time frame or even at the same time, potentially transmitted by multiple transmitters, the apparatus (100;150;200) may not respond, the apparatus may “wake up” only if a clean wake signal is received in embodiments.

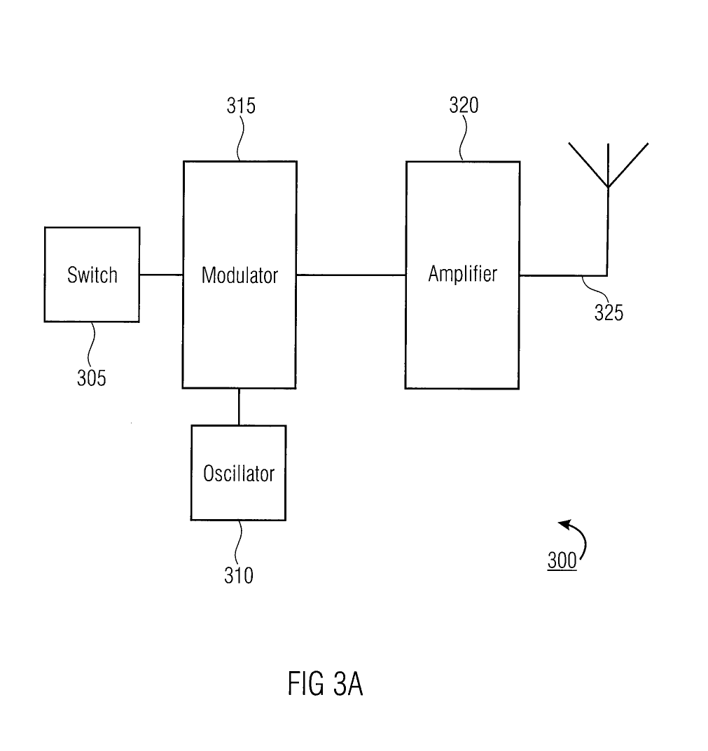

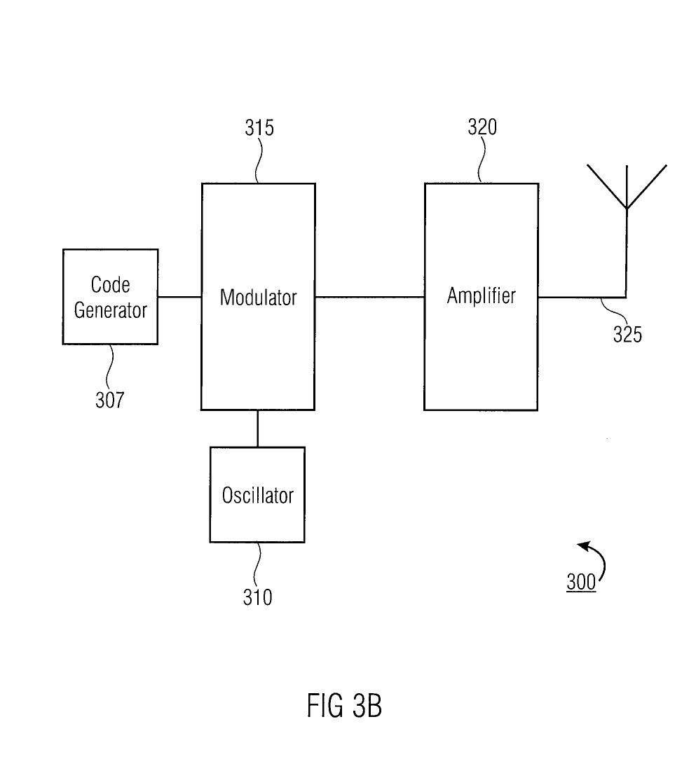

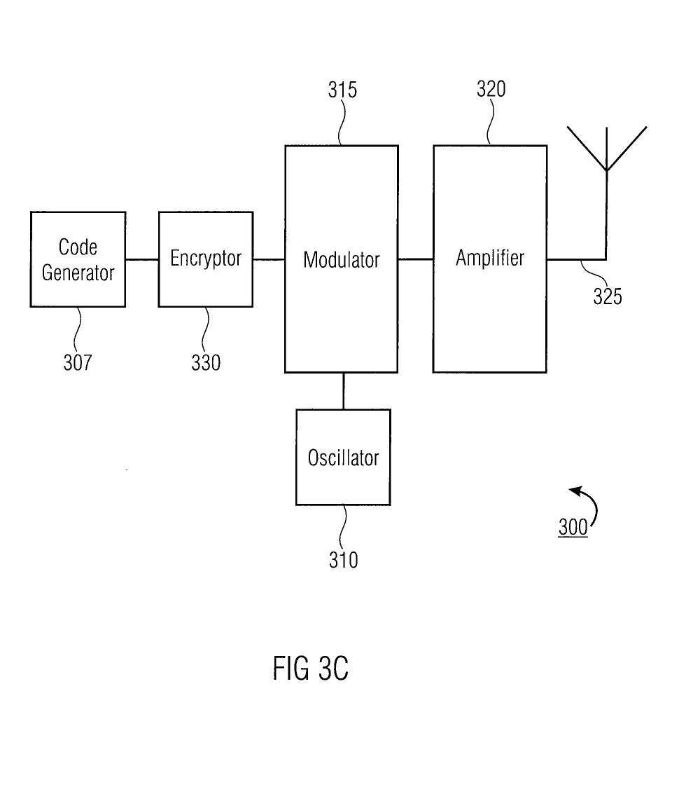

FIG. 3a shows an embodiment of a transmitter or remote control 300. The transmitter 300 may comprise a switch 305 or button for providing a wake up information for a device. Moreover, the transmitter 300 can comprise an oscillator 310 for providing a carrier signal and a modulator 315 for modulating the carrier signal based on the wake up information to obtain a modulated signal. The modulated signal may then be amplified in an amplifier 320 to obtain a transmit signal, which is then transmitted by a transmit antenna 325.

Embodiments comprise a system for waking up a device having a power supply comprising a transmitter for transmitting a transmit wake up signal comprising a modulated carrier and wake up information according to the above description. The system may further comprise a receiver or apparatus (100;150;200) according to the above description.

The main components of a transmitter-circuit 300 may be an on/off switch 305, a modulator 315, an oscillator 310, a power amplifier 320 and a transmit antenna 325. The switch 305 triggers the modulation of a switch on or wake up signal in the modulator 315, where the oscillator 310 provides a carrier signal having an according carrier frequency. The modulated carrier may then be amplified in the amplifier 320 and be transmitted using the transmit antenna 325.

Another embodiment of a transmitter 300 is depicted in FIG. 3b. The embodiment in FIG. 3b comprises similar components as were described and detailed using FIG. 3a, however FIG. 3b utilizes a code generator 307 instead of the switch 305. Therewith an embodiment of a transmitter 300 may be adapted to transmit dedicated transmit signals, wherein the dedication is carried out by the code generator 307. Dedicated codes may be used to address and distinguish multiple devices, e.g. TV, VCR, etc. and accordingly a device may only respond to a certain code.

Yet another embodiment of a transmitter 300 is shown in FIG. 3c, where additionally an encryptor 330 is shown for encrypting a code generated by the code generator. Therewith integrity protection and security can be established for a wake up signal. The encryptor 330 may in embodiments use an energy efficient coding, so enable low energy transmissions of wake up signals. Moreover, in another embodiment the transmitter 300 may comprise a detector configured to detect a collision, i.e. whether other transmitters are active within a certain time frame around its own activity. The transmitter 300 may then be adapted for carrying out a retransmission after a certain time, which may be chosen randomly.

Embodiments utilized in private homes may be implemented in the UHF-band (UHF=Ultra High Frequency). Embodiments may utilize transmit antennas 325 having a radiation characteristic, i.e. directing the transmit power preferably to a certain direction. Generally, embodiments may utilize omni-directional antennas as well. However, embodiments may take advantage of antennas having a directional characteristic, which may enable a lower power consumption and transmission power at a transmitter.

What is claimed is:

1. An apparatus for waking up a device having a power supply, comprising:
a receiver configured to receive a receive signal;
an extractor configured to extract power from the receive signal;
a deriver configured to derive wake up information from the receive signal, which is powered by the extracted power; and
an effecter configured to effect a connection of the device to the power supply if the deriver derives the wake up information.

2. The apparatus of claim 1, wherein the receiver comprises a receive antenna.

3. The apparatus of claim 1, wherein the extractor comprises a rectifier.

4. The apparatus of claim 1, wherein the extractor comprises an energy buffer.

5. The apparatus of claim 1, wherein the extractor comprises a capacitive or inductive element.

6. The apparatus of claim 1, wherein the extractor comprises a controller configured to control the extracted power.

7. The apparatus of claim 1, wherein the deriver comprises a demodulator.

8. The apparatus of claim 1, wherein the effecter is further configured to trigger an electrical or mechanical switch.

9. The apparatus of claim 1, wherein the effecter is further configured to detect a code or identification within the receive signal.

10. The apparatus of claim 9, wherein the effecter is further configured to decrypt the code or identification within the receive signal.

11. The apparatus of claim 1, wherein the effecter is further configured to detect a collision of multiple signals in the receive signal.

12. An apparatus for waking up a device having a power supply, comprising:
an antenna configured to receive a receive signal;
a power extractor coupled to the antenna and configured to extract power from the receive signal; and
a demodulator powered by the power extracted from the receive signal and configured to derive a wake up information and to output a trigger signal for connecting the device to the power supply.

13. The apparatus of claim 12, wherein the power extractor comprises a rectifier.

14. The apparatus of claim 13, wherein the power extractor comprises a controller.

15. The apparatus of claim 14, wherein the power extractor comprises an energy buffer.

16. The apparatus of claim 15, wherein the power extractor comprises a capacitive or inductive element.

17. The apparatus of claim 15, wherein the demodulator is configured to output a trigger signal triggering an electrical or mechanical switch.

18. The apparatus of claim 12, wherein the demodulator is further configured to detect a code or identification within the receive signal.

19. The apparatus of claim 18, wherein the demodulator is further configured to decrypt the code or identification within the receive signal.

20. The apparatus of claim 12, wherein the demodulator is further configured to detect a collision of multiple signals in the receive signal.

21. An apparatus for triggering a wake up of a device having a power supply, comprising:
a receive antenna having a receive signal output;
a power extractor having an input being coupled to the receive signal output and having a power signal output; and
a demodulator having a first input being coupled to the receive signal output and having a second input being coupled to the power signal output, the demodulator further having an output for a trigger signal.

22. A method for waking up a device having a power supply, comprising:
receiving a receive signal;
extracting power from the receive signal;
deriving wake up information from the receive signal, which is powered by the extracted power; and
effecting a connection of the device to the power supply if the wake up information is derived.

23. A system for waking up a device having a power supply, comprising:
a transmitter configured to transmit a transmit wake up signal, the transmit wake up signal comprising a modulated carrier and a wake up information; and
a receiver comprising an apparatus according to claim 1.

24. A system for waking up a device having a power supply, comprising:
a transmitter configured to transmit a transmit wake up signal, the transmit wake up signal comprising a modulated carrier and a wake up information; and
a receiver comprising an apparatus according to claim 9.

25. A system for waking up a device having a power supply, comprising:
a transmitter configured to transmit a transmit wake up signal, the transmit wake up signal comprising a modulated carrier and a wake up information; and
a receiver comprising an apparatus according to claim 15.

26. The system of claim 23, wherein the transmitter comprises a switch configured to provide wake up information for a device, an oscillator configured to provide a carrier signal, a modulator configured to modulate a carrier signal based on a wake up information to obtain a modulated signal, an amplifier configured to amplify the modulated signal to obtain a transmit signal and a transmit antenna configured to transmit the transmit signal.

27. The system of claim 26, wherein the transmitter further comprises a code generator configured to generate a code or identification for a device.

28. The system of claim 27, wherein the transmitter further comprises an encryptor configured to encrypt the code or identification for the device.

29. The system of claim 26, wherein the transmitter further comprises a detector configured to detect a collision of multiple signals and to carry out a retransmission.

30. A device comprising an apparatus for waking up the device according to claim 1.

31. A device comprising an apparatus for waking up the device according to claim 12.

32. A device comprising an apparatus for waking up the device according to claim 21.
